(19) United States
(12) Patent Application Publication
(10) Pub. No.: US 2008/0137032 A1
(43) Pub. Date: Jun. 12, 2008

(54) Optical lens and method of manufacturing

(75) Inventors: Brian Lee Lawrence, Clifton Park, NY (US); Eugene Pauling Boden, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/634,713

(22) Filed: Dec. 6, 2006

(51) Int. Cl. G02C 7/06; B29D 11/00

(52) U.S. Cl. 351/169; 264/1.36

(57) ABSTRACT

The present invention provides a method of modifying a lens, for example an ophthalmic lens. The method comprises providing an optically transparent lens comprising an organic polymer composition containing a photochemically active dye. The optically transparent lens is irradiated with light having a wavelength and an intensity sufficient to transform at least a portion of the photochemically active dye into a photoproduct or photoproducts within the irradiated volume elements of the optically transparent lens to produce refractive index variations in a modified optically transparent lens. In certain embodiments, the modified optically transparent lens is subjected to a stabilization step to provide a light stable modified optically transparent lens. Stabilization is required only when the starting photochemically active dye and/or the photoproduct(s) are unstable under ambient conditions.

### BACKGROUND

The invention relates generally to optical lenses and more particularly to the modification of optical lenses.

Today as many common optical systems are pushed to increasingly higher performance standards including greater magnifications and finer resolutions, the optical elements in these systems are becoming increasingly complex. In many cases, performance can only be achieved by combinations of multiple optical elements or by individual elements with complex designs requiring sophisticated and costly fabrication techniques.

Typically, as the complexity of the optical system grows, the sophisticated functionality needed in the optical system is realized in one of two primary ways. In the first, multiple optical elements are used, for example, to focus beams to diffraction element spots (i.e. multi element microscope objectives), to correct for various aberrations, or to provide distortion free images. In the second, complex optical functionality is generated using a diamond turning process to modify a single optical element. In the diamond turning process, lenses are created with very complicated structures on the lens surface that can provide the necessary function. However, the diamond turning process, while offering dramatically expanded capability over standard lens fabrication processes is still limited in the total performance that can be achieved. Furthermore, the process can entail costs not present in other lens fabrication techniques. In both the multi-element and the single-element techniques, the lens design is generally fixed and offers no variability to compensate for performance changes or tolerances. Hence a simple technique that provides for modifying an optical functionality of a lens, like correction of chromatic or spherical aberrations, control of focal lengths, is highly desirable.

### BRIEF DESCRIPTION

In one embodiment, the present invention provides a method of modifying a lens comprising:

(a) providing an optically transparent lens comprising an organic polymer composition, said polymer composition comprising a photochemically active dye;

(b) irradiating a volume element of the optically transparent lens with light having a wavelength and an intensity sufficient to transform at least a portion of the photochemically active dye into a photo-product within the irradiated volume element of the optically transparent lens to produce refractive index variations, thereby producing a modified optically transparent lens; and optionally

(c) stabilizing the modified optically transparent lens;

to provide a light stable modified optically transparent lens.

In another aspect the present invention provides a modified optically transparent lens produced by the method of the present invention.

In yet another aspect the present invention provides a method for modifying an ophthalmic lens comprising:

(a) providing an optically transparent ophthalmic lens comprising an organic polymer composition, said polymer composition comprising a photochemically active dye;

(b) irradiating a volume element of the optically transparent ophthalmic lens with light having a wavelength and an intensity sufficient to transform at least a portion of the photochemically active dye into a photo-product within the irradiated volume element of the optically transparent lens to produce refractive index variations, thereby producing a modified optically transparent ophthalmic lens; and optionally

(c) stabilizing the modified optically transparent ophtalmic lens;

to provide a light stable modified optically transparent ophthalmic lens.

### DRAWINGS

These and other features, aspects, and advantages of the present invention will become better understood when the following detailed description is read with reference to the accompanying drawings in which like characters represent like parts throughout the drawings, wherein:

FIG. 1 represents the fabrication process of producing an optically transparent lens in accordance with one embodiment of the present invention;

FIG. 2 is a schematic representation of a molded lens exhibiting chromatic aberration;

FIG. 3 depicts the process of generating an interference pattern on an optically transparent lens in accordance with one embodiment of the present invention;

FIG. 4 depicts a modified optically transparent lens with gratings produced using an interference pattern in accordance with one embodiment of the present invention;

FIG. 5 represents a modified optically transparent lens which exhibits reduced or no chromatic aberration in accordance with one embodiment of the present invention;

FIG. 6 is a schematic representation of a molded lens exhibiting spherical aberration;

FIG. 7 depicts an optical system used to generate patterned light for the modification of the optically transparent lens in accordance with one embodiment of the present invention;

FIG. 8 depicts a modified optically transparent lens which exhibits reduced or no spherical aberration in accordance with one embodiment of the present invention;

FIG. 9 depicts a diffractive lens in accordance with one embodiment of the present invention and

FIG. 10 is a schematic representation of a system used for monitoring and dynamically controlling the radiation parameters used for modification of the optically transparent lens.

### DETAILED DESCRIPTION

As defined herein, the term “optically transparent” as applied to an optically transparent lens or an optically transparent polymer means that the lens or the polymer has an absorbance of less than 1. That is, at least 10 percent of incident light is transmitted through the lens or the polymer at least one wavelength in a range between about 320 and about 800 nanometers.

As defined herein, the term “volume element” means a three dimensional portion of a total volume.

As noted, the present invention provides a method for modifying a lens to produce a light stable modified optically transparent lens. Thus, in one aspect, the present invention provides an alternative to lens grinding as a means of modifying a lens. Those skilled in the art will appreciate that just as a single master lens may be ground in various ways to produce any of a variety of discrete optical functionalities, the present invention provides a photochemical means of modifying a master lens to produce the same types of discrete optical functionalities without recourse to grinding techniques and without changing the shape of the master lens. Thus, in one embodiment, the present invention provides a means of modifying a master lens to produce a light stable modified optically transparent lens, said means being conceived of herein as “virtual grinding”. Thus, the present invention provides a method of modifying an optically transparent master lens comprising an optically transparent organic polymer composition, said composition comprising a photochemically active dye. Suitable optically transparent master lenses which are to be modified using the method of the present invention may be provided by any one of the various techniques described herein for preparing optically transparent lenses, for example by injection molding. Selected volume elements within the master lens are then irradiated with light having a wavelength and an intensity sufficient to transform at least a portion of the photochemically active dye into a photo-product within the irradiated volume elements. As a result of this photochemical transformation, refractive index variations within the lens are established. The lens comprising the refractive index variations is referred to as a modified optically transparent lens which may or may not be stable to ambient conditions of light and heat. When the modified optically transparent lens is stable with respect to further photochemical or thermal transformations, the refractive index variations established in the irradiation step are stable and the modified optically transparent lens is said to be “light stable”. Such a modified optically transparent lens is referred to as a light stable modified optically transparent lens. When the modified optically transparent lens is not stable with respect to further photochemical or thermal transformations, the modified optically transparent lens must be subjected to a stabilization step in order to prevent changes in the initially formed refractive index variations, or to preserve the refractive index contrast established in the irradiation step by further transformation of either or both of the photochemically active dye and photo-product(s) to other chemical species. When the modified optically transparent lens is not stable with respect to further photochemical or thermal transformations, it is the product of this stabilization step that is referred to a light stable modified optically transparent lens. Thus, a light stable modified optically transparent lens may be the direct result of irradiating the optically transparent lens started with, or the light stable modified optically transparent lens may result from the combined effects of irradiating the optically transparent lens and stabilizing the modified optically transparent lens.

Non-limiting examples of optically transparent lenses include ophthalmic lenses, gradient index lenses, diffractive lenses, and the like.

In various embodiments, the organic polymer composition is optically transparent. Suitable optically transparent polymers include polycarbonates, olefin polymers, polyesters, polyacrylates, and the like. In one embodiment, the organic polymer composition comprises a polycarbonate, for example bisphenol A polycarbonate. In another embodiment, the organic polymer composition comprises a polymethylmethacrylate, for example PMMA.

As noted, the optically transparent lens comprises an organic polymer composition comprising a photochemically active dye. The photochemically active dye may be any photochemically active molecule which can be used to establish refractive index variations in the modified optically transparent lens and is thus not particularly limited. The photochemically active dye molecule undergoes a light induced chemical reaction when exposed to light to form at least one photo-product. Light induced chemical reactions are illustrated by photo-decomposition reactions, such as oxidations, reductions, bond breaking reactions to form smaller constituents; molecular rearrangements, such as a sigmatropic rearrangements; and addition reactions, including pericyclic cycloadditions. In one embodiment, the photochemically active dye is a photochemically active molecule that has an optical absorption resonance characterized by a center wavelength associated with the maximum absorption and a spectral width (full width at half of the maximum, FWHM) of less than 500 nanometers (hereinafter abbreviated as “nm”).

In one embodiment, the photochemically active dye comprises a nitrostilbene. Examples of nitrostilbenes include but are not limited to 2-nitrostilbene; 2,4-dinitrostilbene; and 4-cyano-2-nitrostilbene; and the like. In an alternate embodiment, the photochemically active dye comprises a diarylethene, for example diarylperfluorocyclopentenes; diarylmaleic anhydrides; diarylmaleimides; or a combination comprising at least one of the foregoing diarylethenes. In yet another embodiment, the photochemically active dye comprises a nitrone. Suitable examples of nitrones include but are not limited to α-(4-diethylaminophenyl)-N-phenylnitrone; α-(4-diethylaminophenyl)-N-(4-chlorophenyl)-nitrone, α-(4-diethylaminophenyl)-N-(3,4-dichlorophenyl)-nitrone, α-(4-diethylaminophenyl)-N-(4-carbethoxyphenyl)-nitrone, α-(4-diethylaminophenyl)-N-(4-acetylphenyl)-nitrone, α-(4-dimethylaminophenyl)-N-(4-cyanophenyl)-nitrone, α-(4-methoxyphenyl)-N-(4-cyanophenyl)nitrone, α-(9-julolidinyl)-N-phenylnitrone, α-(9-julolidinyl)-N-(4-chlorophenyl)nitrone, α-[2-(1,1-diphenylethenyl)]-N-phenylnitrone, α-[2-(1-phenylpropenyl)]-N-phenylnitrone, like nitrones, and a combination comprising at least one of the foregoing nitrones. In one embodiment, the photochemically active dye comprises at least one dye selected from the group consisting of nitrostilbenes, vicinal diarylethenes, and nitrones. For example, in one embodiment, the photochemically active dye comprises a mixture, which includes a nitrostilbene photochemically active dye, a vicinal diarylethene photochemically active dye, and a nitrone photochemically active dye. In one embodiment, the photochemically active dye is selected from the group consisting of 4-dimethylamino-2′,4′-dinitrostilbene; 4-dimethylamino-4′-cyano-2′-nitrostilbene; 4-hydroxy-2′,4′-dinitrostilbene; and combinations thereof.

In one embodiment, the photochemically active dye is present in an amount from about 0.1 to about 30 weight percent, based on the total weight of the optically transparent lens. In yet another embodiment, the photochemically active dye is present in an amount from about 0.1 to about 20 weight percent, based on the total weight of the optically transparent lens. In still yet another embodiment, the photochemically active dye is present in an amount from about 0.1 to about 5 weight percent, based on the total weight of the optically transparent lens.

In one embodiment, the optically transparent lens has a UV-visible absorbance in a range between about 0.1 and 1 at least one wavelength in a range between about 320 nm and about 800 nm. In an alternate embodiment, the optically transparent lens has a UV-visible absorbance in a range between about 0.1 and 1 at least one wavelength in a range between about 320 nm and about 600 nm. In yet another embodiment, the optically transparent lens has a UV-visible absorbance in a range between about 0.1 and 1 at least one wavelength in a range between about 320 nm and about 400 nm.

In one embodiment, the optically transparent lens is provided by first compounding an optically transparent polymer, for example polycarbonate, with a photochemically active dye to provide an organic polymer composition. Suitable means of compounding the optically transparent polymer with the photochemically active dye include mixing methods using machines such as a single or multiple screw extruder, a Buss kneader, a Henschel mixer, a helicone mixer, an Eirich mixer, a Ross mixer, a Banbury mixer, a roll mill, and the like. In one embodiment, the compounding of the optically transparent polymer with the photochemically active dye is carried out in an extruder.

The organic polymer composition may be transformed into an optically transparent lens by a variety of means. For example, various molding and/or processing techniques can be used for forming an optically transparent lens from the organic polymer composition. Suitable techniques include injection molding, injection-compression molding, press molding, and the like. In one embodiment, the optically transparent lens is formed using an injection molding machine.

The optically transparent lens is also at times herein referred to, as the “starting lens”. In one embodiment, the starting lens is a convergent lens. In an alternate embodiment, the optically transparent lens is a divergent lens. Those skilled in the art will understand that the starting lens can be such that it provides a light converging or a light diverging functionality based on the molded shape of the starting lens. Non-limiting examples of the shape of the starting lens include a double convex shape, a bi-convex shape, plano-convex shape, concave convex shape, double concave shape, plano-concave shape, and a convexo-concave shape. In one embodiment the starting lens is an ophthalmic lens having a convex shaped surface and a concave shaped surface.

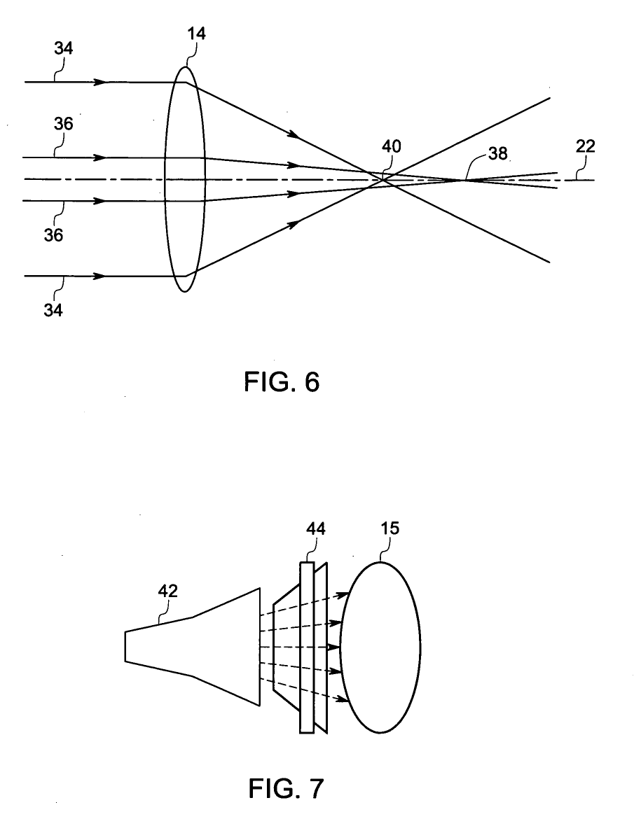

One advantage provided by the present invention is that lenses may be tailored to suit their intended purpose without requiring a change in the shape of the lens. For example, the starting lens may have undesirable chromatic and/or spherical aberrations which may be reduced or eliminated using the method of the present invention. Chromatic aberration relates to differences in focal points for different wavelengths of light passing through the lens. A lens exhibiting chromatic aberration will focus light of different wavelengths at different positions. Chromatic aberration is illustrated in FIG. 2. Spherical aberration is typically observed in spherical lenses. Light rays incident at the outer edges of a spherical lens focus at a different focal point as compared to light rays incident closer to the optical axis of the lens. Spherical aberration is illustrated in FIG. 6.

As noted, the method of the present invention comprises irradiating the optically transparent lens with light from a light source such that individual volume elements of the optically transparent lens are exposed to radiation having a wavelength and an intensity sufficient to transform at least a portion of the photochemically active dye into a photo-product within the irradiated volume elements of the lens to produce refractive index variations among the volume elements. In one embodiment, the light source is a coherent source such as laser. In another embodiment, the light source is an incoherent light source. In some embodiments the light source is a ultra-violet light source, for example a UV lamp.

In one embodiment, the optically transparent lens is irradiated using patterned radiation. Patterned radiation is formed by passing the light generated by the light source through a photo-mask. Photo-masks may be created by various techniques such as photo-lithography, screen printing, ink-jet printing, and the like. In another embodiment, the optically transparent lens is irradiated using an interference pattern. An interference pattern is created by intersection of two beams of light and may be recorded or fixed in a photosensitive medium such as the optically transparent lens.

In some embodiments, the optically transparent lens is irradiated with a light source while monitoring an optical property of the optically transparent lens. The information can be used to dynamically control the irradiation parameters such as wavelength, intensity, and exposure time. In one embodiment, the optically transparent lens is irradiated with a light having a wavelength in the range of 320 nm to 800 nm. In another embodiment, the optically transparent lens is irradiated with a light having a wavelength in the range 320 nm to 600 nm. In still yet another embodiment, the optically transparent lens is irradiated with a light having a wavelength in the range 320 nm to 400 nm.

Upon irradiation, the photochemically active dye in the optically transparent lens undergoes a photochemical reaction to form a photo-product which results in refractive index variations among the individual volume elements of the optically transparent lens. Because of the photochemical reaction, irradiated volume elements exhibit refractive indices which are different from the refractive index of the corresponding non-irradiated volume elements. Thus the optically transparent lens is transformed into a modified optically transparent lens. In one embodiment, the refractive index change before and after irradiation is in the range from about 0.01 to about 0.1. In an alternate embodiment, the refractive index change before and after irradiation is in the range from about 0.02 to about 0.08. In yet another embodiment, the refractive index change before and after irradiation is in the range from about 0.03 to about 0.06.

In one embodiment, the modified optically transparent lens is a gradient index lens. This gradient index lens has a refractive index profile, which varies in one or multiple directions. This refractive index profile can be generated by appropriate selection of wavelength and intensity of light used. In one embodiment, the optically transparent lens is irradiated with a light having a wavelength in the range of 320 nm to 800 nm to form a gradient index lens.

In another embodiment, the modified optically transparent lens is a diffractive lens having diffractive gratings. These gratings may be utilized to separate incoming light beams and focus which exit the lens and focused at different focal points. In one embodiment, a diffractive lens can be formed by irradiating an optically transparent lens using an interference pattern.

In another embodiment, the modified optically transparent lens is an ophthalmic lens. Ophthalmic lenses are optical lenses used for the modification or correction of the vision of patients, in particular of those suffering from defects of vision such as short-sightedness or long-sightedness. Although this disclosure is primarily intended for the benefit of human patients, the inventors conceive in one aspect, that their invention may be used for the benefit of any warm blooded animal suffering from a defect in vision or needing a modification of its normal field of vision, for example lenses intended to modify the field of vision of draft animals. In one embodiment, the optically transparent ophthalmic lens may be irradiated with patterned radiation to produce the desired refractive index variations. Changes in the refractive indices among the individual volume elements comprising the ophthalmic lens can be used to control the focal length of the lens. In one embodiment, the modified optically transparent ophthalmic lens exhibits a focal length which is longer than the focal length of the optically transparent ophthalmic lens prior to modification. In another embodiment, the modified optically transparent ophthalmic lens exhibits a focal length, which is shorter than the focal length of the optically transparent ophthalmic lens prior to modification.

Following the irradiation step, the modified optically transparent lens optionally may be subjected to a stabilization step to provide a light stable modified optically transparent lens. In certain embodiments, both the photochemically active dye and the photoproduct(s) generated upon irradiation, are essentially stable under the conditions of their intended use, for example ambient conditions of temperature and illumination. That is, neither the photochemically active dye nor the photo-product undergoes significant chemical reaction under ambient conditions, for example the photo-product is stable with respect to reversion back to the photochemically active dye. Hence in such cases, an independent stabilization step is not required in order to produce the light stable modified optically transparent lens. However, it is possible that, in some types of dyes, the unconverted photochemically active dye or a product derived from it is thermally or photochemically unstable. In such cases, the refractive index contrast generated between the volume elements in the modified optically transparent lens may be subject to change over a relatively short period of time. Hence, in some embodiments, the modified optically transparent lens requires an independent stabilization step in order to provide a light stable modified optically transparent lens. In one example, the stabilization step comprises further irradiating the modified optically transparent lens at an appropriate wavelength in order to convert unreacted photochemically active dye and/or an unstable photoproduct to a more stable form. For example, the optically transparent lens is initially irradiated at a first wavelength to produce a desired refractive index contrast in the modified optically transparent lens, and subsequently the modified optically transparent lens is irradiated a second wavelength to produce a light stable modified optically transparent lens in which the desired refractive index contrast is preserved. In another embodiment, an ultra-violet light screening coating may be provided to protect the modified optically transparent lens from the effects of further irradiation. In yet another embodiment, the modified optically transparent lens may be stabilized by a thermal treatment, for example heating the initially formed modified optically transparent lens to provide a light stable modified optically transparent lens.

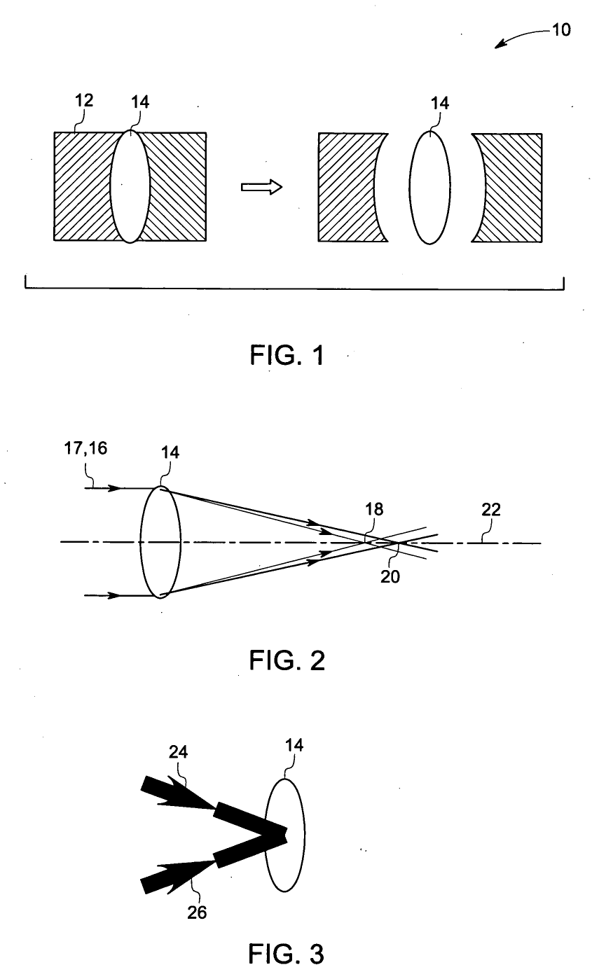

Various aspects of the invention are shown in FIGS. 1-10 and are explained in greater details below. FIG. 1 depicts a process 10 of molding a lens, in accordance with one embodiment of the present invention. As illustrated in FIG.1, a mold 12 is used to provide a desired shape to an organic polymer composition to form an optically transparent lens 14. In one embodiment, the molded optically transparent lens 14 may have chromatic or spherical aberrations. Chromatic aberration is illustrated in FIG. 2 Light with longer wavelength as indicated by 16 focuses at a focal point 20, whereas light with shorter wavelength as indicated by 17 will focus at a focal point 18 on optical axis 22.

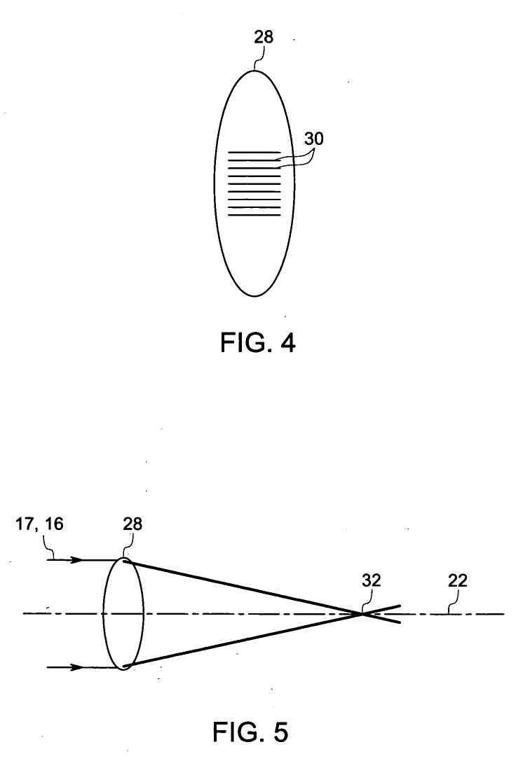

In one aspect, chromatic aberration may be corrected or reduced using the method of the present invention. In one embodiment, the starting lens is irradiated with an interference pattern to correct or reduce an optical defect. As shown in FIG. 3 an interference pattern may be created in optically transparent lens 14 using a first light beam 24 and a second light beam 26 which intersect to form an interference pattern (not shown) which is used to irradiate individual volume elements of the optically transparent lens. Thus, the starting lens is transformed into a modified optically transparent lens. This modified optically transparent lens is illustrated as 28 in FIG. 4. The grating created by the interference pattern is shown as 30. As shown in FIG. 5, the modified optically transparent lens exhibits reduced or no chromatic aberration relative to the lens prior to modification and light of different wavelengths 16 and 17 focus at a common focal point 32 on optical axis 22. Spherical aberration is depicted in FIG. 6. Light incident at the outer edges of lens 14 as indicated by 34, focuses at a focal point 40, whereas the light indicated as 36 incident at the lens closer to the optical axis 22 focuses at focal point 38.

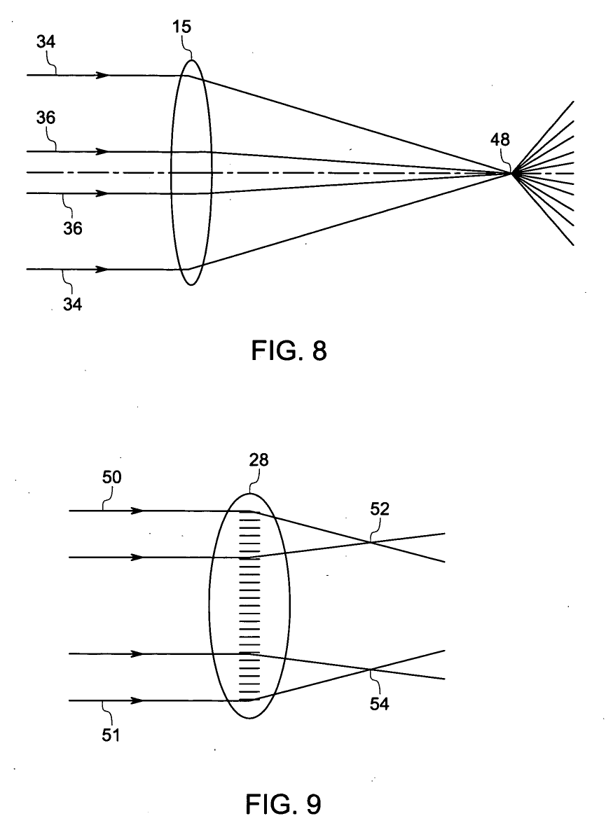

In one embodiment of the invention, in order to correct for spherical aberrations, patterned light may be used as shown in FIG. 7. A light source 42 provides the light with desired wavelength. A mask 44 is used to create the patterned light. The starting lens is then irradiated with the patterned light to produce the refractive index variations in the modified optically transparent lens 15. A modified optically transparent lens 15 exhibiting no spherical aberration is illustrated in FIG. 8 where light rays 34 and 36 focus at a common focal point 48.

Referring to FIG. 9, in one embodiment, the modified optically transparent lens is a diffractive lens 28. In one embodiment, diffractive lens 28 is capable of providing a light converging function at multiple focal points along a plane perpendicular to the optical axis. Beams 50 and 51 focus at different focal points 52 and 54 based on diffractive gratings generated in the diffractive lens during the lens modification process.

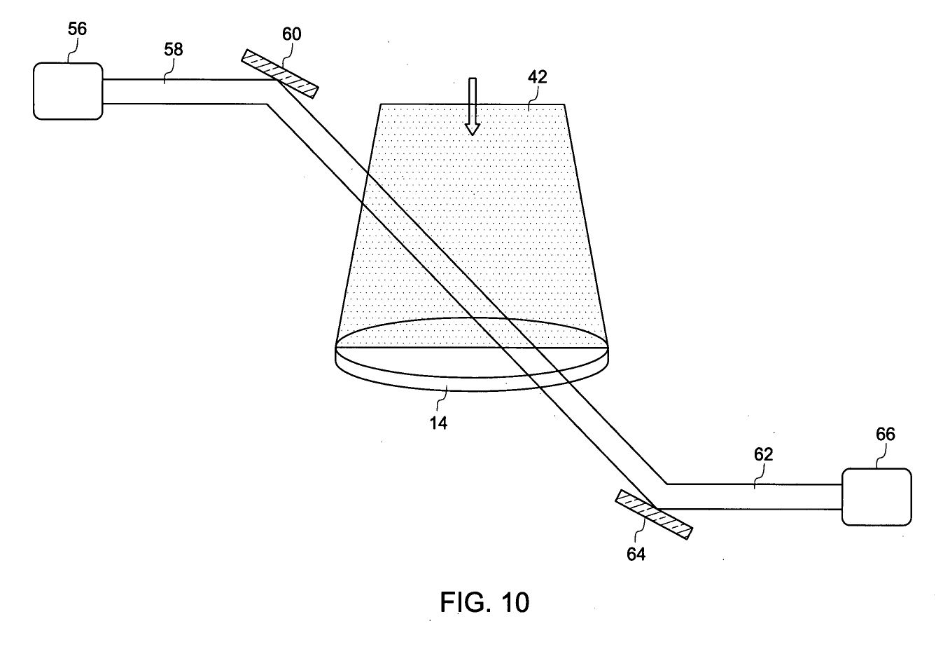

In another embodiment, the method further comprises monitoring an optical property of the lens during irradiation to dynamically control irradiation parameters. FIG. 10 is a schematic representation of a system used for monitoring and dynamically controlling the irradiation parameters used for modification of the optically transparent lens. The system includes a laser source 56 and a detector 66. Mirror 60 is used for directing the monitoring beam 58 towards the starting lens 14, whereas mirror 64 is used for directing the transmitted monitoring beam 62 towards the detector. Light source 42 is used for irradiating the starting lens. During irradiation, the transmitted monitoring beam measures the optical property of the lens and feeds the information to the detector. This information is then utilized to dynamically control the radiation parameters such as wavelength, intensity and exposure time.

In classical optics, a standard plano-convex positive lens consists of a lens fabricated from a glass with a uniform, homogeneous refractive index, and with one flat surface and one surface polished to a desired radius of curvature. The focal length of the lens can then be calculated from the lens maker's equation given in equation 1, where one of the two radii of curvature is infinite for a planar surface.

$$f = \frac{{R}_{1}}{( {n}_{lens} - {n}_{o} )} \qquad Equation 1$$

where R₁ is the radius of curvature of the convex surface, nₗₑₙₛ is the refractive index of the homogeneous lens material, and n₀ is the index of the surrounding media, which is typically air. While spherical convex surfaces are the simplest to prepare using standard polishing techniques, they also result in spherical aberrations. Spher ical aberration as shown in FIG. 6 results from light at the periphery of the lens focusing more tightly than light passing through the center of the lens, producing a focal spot that is considerably larger and more blurred or spread out than an ideal lens.

One way to correct for spherical aberration is to add aspheric correction terms to the surface. This results in a surface that deviates from a perfect sphere in a way that minimizes aberrative effects. However, this requires that lenses be polished with non-spherical surfaces, which is more difficult and expensive than fabricating standard spherical lenses. Another approach to fabricating aspheric lenses corrected to minimize spherical aberration is to use a lens with standard spherical surfaces but fabricated from materials with radial gradient index variations. One technique to produce materials with radial gradient index variations is to start with a rod of multi-component glass and to use ion exchange processing to exchange ions in the glass thereby reducing the local refractive index. Due to diffusion, ions will more readily exchange at the perimeter of the rod reducing the refractive index more at the periphery than at the center producing a smooth gradient in refractive index from the lowest index at the perimeter to the highest index at the center. However, this process can be expensive and time consuming and it can also alter the mechanical properties of the glass, complicating polishing processes.

In one embodiment, the method of the present invention can be used to provide a modified optically transparent lens which is a gradient index lens having one or more spherical surfaces. The desired gradient index lens is prepared by first providing an optically transparent lens having one or more spherical surfaces, said optically transparent lens comprising an organic polymer composition and a photochemically active dye. The optically transparent lens can be formed by, for example, injection molding. The optically transparent lens is then exposed to a radial pattern at a desired wavelength of light to modify the refractive index of targeted volume elements within the starting optically transparent lens to provide for a smooth gradient in the refractive index from center to edge. Thus, in one embodiment, a polymer composition comprising polystyrene and 20 wt. % the nitrone dye α-[p-(dimethylamino)styryl]-N-phenyl nitrone is used to mold a plano-convex spherical lens with a diameter of 4 mm and a first surface radius of curvature of 3.254 mm. Due to the spherical nature of the convex surface, this lens exhibits significant spherical aberration as shown FIG. 6. To correct for the spherical aberration, the refractive index must be varied in a radially graded fashion. The index variation can be calculated from equation 2 as shown by H. Nishi, et. al., in “Gradient-index objective lens for the compact disk system,” Applied Opt., vol. 25, pg. 3340 (1986);

n²(r)=n₀²└1−(gr)²+h₄(gr)⁴+h₆(gr)⁶+ . . . ┘ Equation 2

where n₀ is the maximum homogenous refractive index, g is the quadratic gradient-index contact, and h₄, h₆ are higher-order gradient index coefficients. Standard ray-tracing calculations can then be used to determine the optimum set of coefficients to correct for the spherical aberration. A set of coefficients applicable for use in the present example is given in Table 1.

TABLE 1
Lens Design Parameters For CD Optical
Pickup

| | |
|---|---|
| R₁ = 3.254 mm | R₂ = ∞ |
| Thickness = 1.884 mm | nₒ = 1.58 |
| g = 0.1273 | h₄ = −0.863 |
| h₆ = −0.653 | h₈ = −66.9 |

The radial refractive index variation corresponding to the values shown in Table 1 for the optically transparent lens of the present example indicates a maximum reduction in refractive index needed at the perimeter of the lens of about 0.056 relative to n₀, the maximum homogenous refractive index of the starting optically transparent lens (1.58). To create this refractive index variation, the lens is irradiated with patterned light corresponding to an intensity distribution such that the perimeter of the starting optically transparent lens is strongly irradiated while the portion of the optically transparent lens closest to the optical axis undergoes little or no irradiation. In this example, the lens is designed for use in a compact disk system having a read wavelength of 780 nm. Using the extended CEM 388 nitrone dye, a 500 mW CW green laser at 532 nm may be used to expose the lens. The laser light is first incident on a transmission mask that transmits more light at the perimeter of the mask than at the center so as to provide the desired intensity pattern to produce the desired refractive index variation. The resultant modified optically transparent lens exhibits reduced spherical aberration relative to the starting optically transparent lens, resulting in improved (smaller) spot dimensions at the focus of the lens.

As an alternative embodiment, the same material and configuration may be used with the addition of a 780 nm laser diode passing through the lens during green laser exposure to act as a monitor for in situ measurement of the aberrations. Therefore, the magnitude of the index change does not have to be determined in advance, but instead the exposure is continued until the desired performance is achieved at 780 nm. Thus, in this embodiment, an optical property of the optically transparent lens is monitored during irradiation to dynamically control irradiation parameters.

While only certain features of the invention have been illustrated and described herein, many modifications and changes will occur to those skilled in the art. It is, therefore, to be understood that the appended claims are intended to cover all such modifications and changes as-fall within the true spirit of the invention.

1. A method of modifying a lens comprising:
(a) providing an optically transparent lens comprising an organic polymer composition, said polymer composition comprising a photochemically active dye;
(b) irradiating a volume element of the optically transparent lens with light having a wavelength and an intensity sufficient to transform at least a portion of the photochemically active dye into a photo-product within the irradiated volume element of the optically transparent lens to produce refractive index variations, thereby producing a modified optically transparent lens; and optionally
(c) stabilizing the modified optically transparent lens;
to provide a light stable modified optically transparent lens.

2. The method of claim 1, wherein said irradiating comprises irradiating with patterned radiation.

3. The method of claim 1, wherein said irradiating comprises irradiating with an interference pattern.

4. The method of claim 1, wherein said wavelength is in a range from about 320 nm to about 800 nm.

5. The method of claim 1, wherein the optically transparent lens is convergent.

6. The method of claim 1, wherein the optically transparent lens is divergent.

7. The method of claim 1, further comprising monitoring an optical property of the optically transparent lens during irradiation to dynamically control irradiation parameters.

8. The method of claim 1, wherein the photochemically active dye is selected from the group consisting of vicinal diarylethenes, nitrones, nitrostilbenes, and combinations thereof.

9. The method of claim 1, wherein the photochemically active dye is a vicinal diarylethene selected from the group consisting of diarylperfluorocyclopentenes, diarylmaleic anhydrides, diarylmaleimides and combinations thereof.

10. The method of claim 1, wherein the photochemically active dye is selected from a group consisting of 4-dimethylamino-2′,4′-dinitrostilbene; 4-dimethylamino-4′-cyano-2′-nitrostilbene; 4-hydroxy-2′,4′-dinitrostilbene; and combinations thereof.

11. The method of claim 1, wherein the photochemically active dye is present in an amount corresponding to from about 0.1% to from about 30% based on a total weight of the polymer composition.

12. The method of claim 1, wherein the photochemically active dye is present in an amount corresponding to from about 0.1% to from about 20% based on a total weight of the polymer composition.

13. The method of claim 1, wherein the photochemically active dye is present in an amount corresponding to from about 0.1% to from about 5% based on a total weight of the polymer composition.

14. The method of claim 1, wherein the polymer composition comprises polycarbonate.

15. A modified optically transparent lens made in accordance with the method of claim 1.

16. The modified optically transparent lens of claim 15 which is a gradient index lens.

17. The modified optically transparent lens of claim 15 which is an ophthalmic lens.

18. The modified optically transparent lens of claim 15 which is a diffractive lens.

19. A method of modifying an ophthalmic lens comprising:
(a) providing an optically transparent ophthalmic lens comprising an organic polymer composition, said polymer composition comprising a photochemically active dye;
(b) irradiating a volume element of the optically transparent ophthalmic lens with light having a wavelength and an intensity sufficient to transform at least a portion of the photochemically active dye into a photo-product within the irradiated volume element of the optically transparent lens to produce refractive index variations, thereby producing a modified optically transparent ophthalmic lens; and optionally
(c) stabilizing the modified optically transparent ophtalmic lens;
to provide a light stable modified optically transparent ophthalmic lens.

20. The method according to claim 19, wherein said polymer composition comprises polycarbonate.

21. The method according to claim 19, wherein said polymer composition comprises polymethylmethacrylate.

22. The method according to claim 19, wherein the modified optically transparent ophthalmic lens exhibits a focal length which is shorter than the focal length of the optically transparent ophthalmic lens prior to modification.

23. The method according to claim 19, wherein the modified optically transparent ophthalmic lens exhibits a focal length which is longer than the focal length of the optically transparent ophthalmnic lens prior to modification.

24. The method according to claim 19, wherein the modified optically transparent ophthalmic lens exhibits reduced chromatic aberration relative to the optically transparent ophthalimic lens prior to modification.

25. The method according to claim 19, wherein the modified optically transparent ophthalmic lens exhibits reduced spherical aberration relative to the optically transparent ophthalmic lens prior to modification.

26. The method according to claim 19, wherein said optically transparent ophthalmic lens is a master lens.
